(19) United States
(12) Patent Application Publication
(10) Pub. No.: US 2013/0027322 A1
(43) Pub. Date: Jan. 31, 2013

(54) DISPLAY SCREEN AND DISPLAY DEVICE

(71) Applicants: YU-JU HSU, Tu-Cheng (TW); PO-SHENG SHIH, Tu-Cheng (TW)

(72) Inventors: YU-JU HSU, Tu-Cheng (TW); PO-SHENG SHIH, Tu-Cheng (TW)

(73) Assignee: SHIH HUA TECHNOLOGY LTD., Zhunan (TW)

(21) Appl. No.: 13/337,175

(22) Filed: Dec. 26, 2011

(30) Foreign Application Priority Data
Jul. 26, 2011 (TW) 100126265

(51) Int. Cl. G06F 3/041; G02B 5/20; B82B 1/00; B82Y 20/00

(52) U.S. Cl. 345/173; 359/890; 977/742; 977/952

(57) ABSTRACT

A display screen including an optical element and a chromaticity improving layer is provided. A light transmittance of the optical element to visible light having short wavelengths is lower than a light transmittance to visible light having long wavelengths. A light transmittance of the chromaticity improving layer to visible light having short wavelengths is higher than a light transmittance to visible light having long wavelengths. A display device using the display screen is also provided.

### CROSS-REFERENCE TO RELATED APPLICATIONS

This application claims all benefits accruing under 35 U.S.C. §119 from Taiwan Patent Application No. 100126265, filed on Jul. 26, 2011 in the Taiwan Intellectual Property Office, the disclosure of which is incorporated herein by reference. This application is related to an application entitled, “TOUCH PANEL AND DISPLAY DEVICE,” filed ______ (Atty. Docket No. US39788).

### BACKGROUND

1. Technical Field

The present disclosure relates to a display screen and a display device.

2. Discussion of Related Art

A conventional display device includes a touch panel, a touch panel controller, a central processing unit (CPU), a display screen, and a display screen controller. The touch panel is disposed opposite and adjacent to the display screen. The touch panel is electrically connected to the touch panel controller. The display screen is electrically connected to the display screen controller. The touch panel controller, the CPU, and the display screen controller are electrically connected. The touch panel can be a resistance touch panel or a capacitance touch panel.

Users can operate the display device by pressing or touching the touch panel with a finger, a pen, or a stylus, while visually observing the display screen through the touch panel. However, because different optical elements in the display device have different light transmittance to different wavelengths of visible light. When light irradiating from the display screen passes through the optical elements of the display device, a chromaticity will exist on the display device, and a color distortion will exist on the display device. For example, when the transparent conductive layer of the touch panel is a transparent carbon nanotube film, because a light transmittance of the transparent carbon nanotube film to short wavelengths of visible light having is lower than the light transmittance to long wavelengths of visible light, a chromaticity will exist on the display device. Therefore, a color distortion will exist on the display device to influence the visual effect.

What is needed, therefore, is to provide a display screen and a display device having low chromaticity, which can overcome the above-described shortcomings.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a cross-sectional view of one embodiment of a display device.

FIG. 2 is a cross-sectional view of a touch panel used in the display device of FIG. 1.

FIG. 3 is a top view of the touch panel of FIG. 2.

FIG. 4 is a Scanning Electron Microscope (SEM) image of a drawn carbon nanotube film.

FIG. 5 shows one embodiment of a process of drawing a carbon nanotube film from a carbon nanotube array.

FIG. 6 is an isometric view of a display screen used in the display device of FIG. 1.

FIG. 7 is a cross-sectional view of another embodiment of a display device.

FIG. 8 is an isometric view of a display screen used in the display device of FIG. 7.

FIG. 9 is a cross-sectional view of a substrate of the display screen of FIG. 8.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

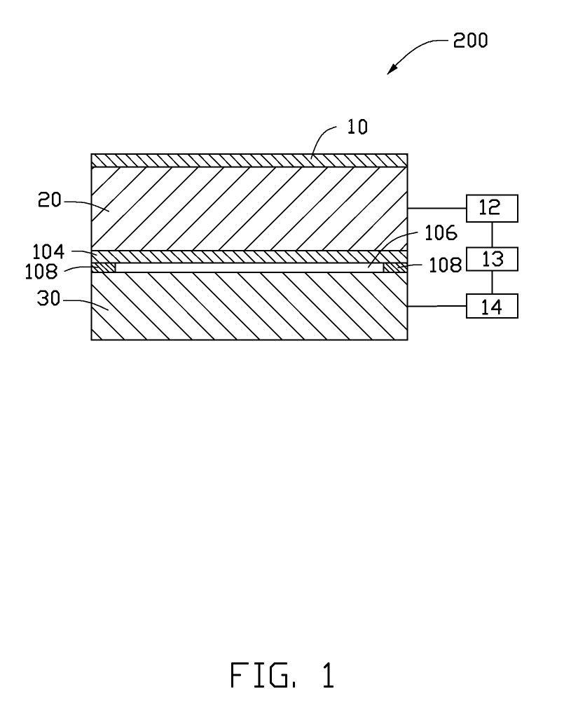

Referring to FIG. 1, a display device 100 of one embodiment is provided. The display device 100 includes a chromaticity improving layer 10, a touch panel 20, a display screen 30, a first controller 12, a central processing unit (CPU) 13, and a second controller 14.

The chromaticity improving layer 10, the touch panel 20, and the display screen 30 are stacked one by one to form a layer structure. The first controller 12 is electrically connected to the touch panel 20 to control the touch panel 20. The second controller 14 is electrically connected to the display screen 30 to control the display screen 30. The first controller 12, the CPU 13, and the second controller 14 are electrically connected with each other.

The touch panel 20 can be located apart from the display screen 30 or installed directly on the display screen 30. A passivation layer 104 can be located between the touch panel 20 and the display screen 30. A material of the passivation layer 104 can be benzocyclobutene, polyester, acrylics, or other flexible materials. The passivation layer 104 can be spaced from the display screen 30 a certain distance or installed on the display screen 30 directly. In one embodiment, two supports 108 are located between the passivation layer 104 and the display screen 30 to separate the touch panel 20 from the display screen 30. A gap 106 is defined by the passivation layer 104, the two supports 108, and the display screen 30. The passivation layer 104 can be used to protect the display screen 30 from mechanical damage.

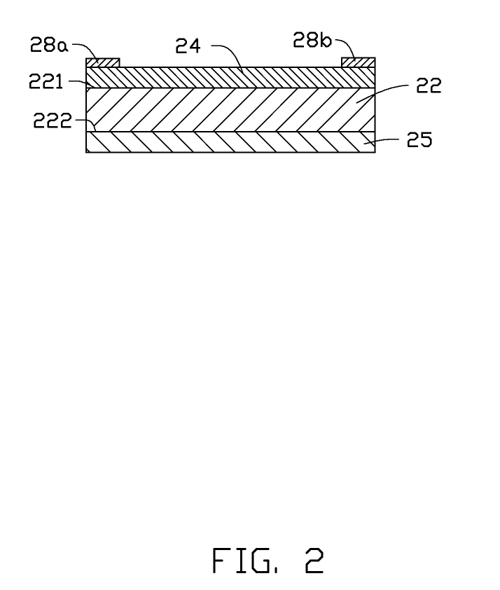

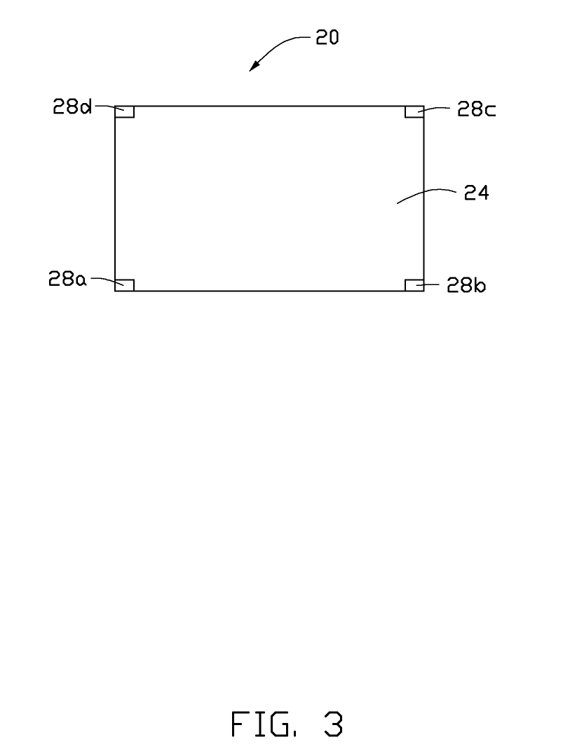

The touch panel 20 can be a resistance touch panel or a capacitance touch panel. In one embodiment, the touch panel 20 is a capacitance touch panel. Referring to FIGS. 2 and 3, the touch panel 20 includes a substrate 22, a transparent conductive layer 24, and four electrodes 28a, 28b, 28c, 28d.

The substrate 22 has a first surface 221 and a second surface 222 opposite to the first surface 221. The substrate 22 is transparent and insulative. The first surface 221 and the second surface 222 can be curved or planar. A material of the substrate 22 can be glass, quartz, diamond, or plastic. In one embodiment, the substrate 22 is a glass.

The transparent conductive layer 24 is a transparent carbon nanotube layer located on the first surface 221. The transparent carbon nanotube layer can include at least one carbon nanotube film, and can be formed by a plurality of coplanar or stacked carbon nanotube films. A thickness of the transparent conductive layer 24 is not limited, as long as the transparent conductive layer 24 has a transmittance higher than 70%. Because the transparent carbon nanotube layer has different light transmittance to different wavelengths of visible light, when light passes through the transparent conductive layer 24, a chromaticity will exist on the touch panel 20. The chromaticity of the touch panel 20 is related to the thickness of the transparent conductive layer 24. The thickness of the transparent conductive layer 24 can be defined as A₁ micrometers.

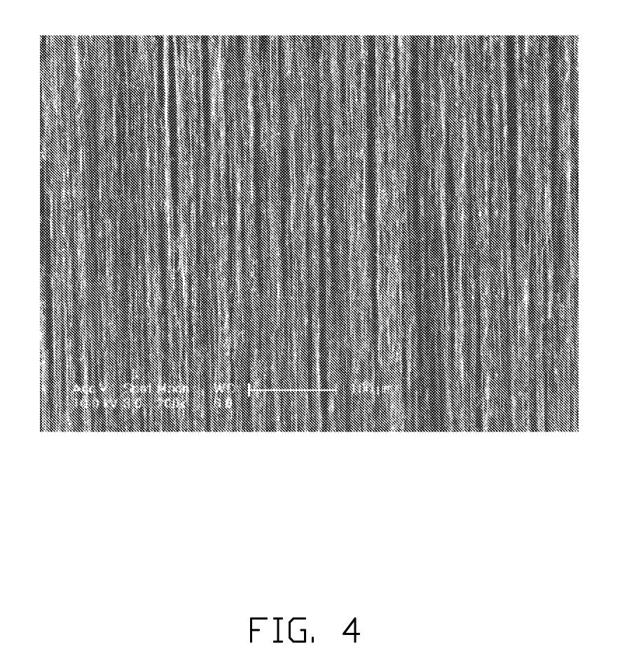

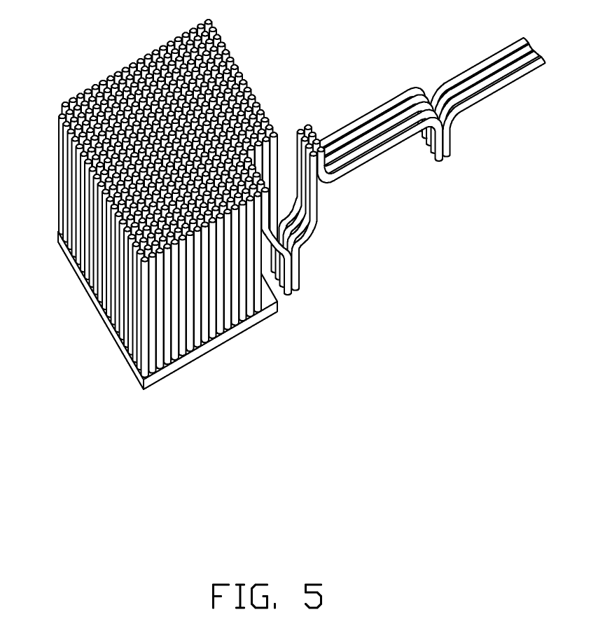

Referring to FIGS. 4 and 5, the carbon nanotube film can be a drawn carbon nanotube film formed by drawing from a carbon nanotube array. In one embodiment, the transparent conductive layer 24 includes one drawn carbon nanotube film. The drawn carbon nanotube film can include a plurality of successive and oriented carbon nanotubes joined end to end by van der Waals attractive force. Each drawn carbon nanotube film can include a plurality of successively oriented carbon nanotube segments joined end-to-end by van der Waals attractive force therebetween. Each carbon nanotube segment includes a plurality of carbon nanotubes substantially parallel to each other, and combined by van der Waals attractive force therebetween. A thickness of the drawn carbon nanotube film can be in a range from about 0.5 nanometers to about 100 micrometers. In one embodiment, the thickness of the drawn carbon nanotube film is about 0.3 micrometers. The plurality of carbon nanotubes can be single-wall carbon nanotube, double-wall carbon nanotube, and multi-wall carbon nanotube. A diameter of the single-wall carbon nanotube can be in a range from about 0.5 nanometers to about 50 nanometers. A diameter of the double-wall carbon nanotube can be in a range from about 1 nanometer to about 50 nanometers. A diameter of the multi-wall carbon nanotube can be in a range from about 1.5 nanometers to about 50 nanometers.

The drawn carbon nanotube film can be formed by the steps of: (a) providing an array of carbon nanotubes, or a super-aligned array of carbon nanotubes; and (b) pulling out a carbon nanotube film from the array of carbon nanotubes using a tool (e.g., adhesive tape, pliers, tweezers, or another tool allowing multiple carbon nanotubes to be gripped and pulled simultaneously).

In step (a), a given super-aligned array of carbon nanotubes can be formed by the sub-steps of: (a1) providing a substantially flat and smooth substrate; (a2) forming a catalyst layer on the substrate; (a3) annealing the substrate with the catalyst layer in air at a temperature in a range from about 700° C. to about 900° C. for about 30 minutes to about 90 minutes; (a4) heating the substrate with the catalyst layer to a temperature in the a range from about 500° C. to about 740° C. in a furnace with a protective gas therein; and (a5) supplying a carbon source gas to the furnace for about 5 minutes to about 30 minutes and growing the super-aligned array of carbon nanotubes on the substrate.

In step (a1), the substrate can be a P-type silicon wafer, an N-type silicon wafer, or a silicon wafer with a film of silicon dioxide thereon. A 4-inch P-type silicon wafer is used as the substrate in the present embodiment.

In step (a2), the catalyst can be made of iron (Fe), cobalt (Co), nickel (Ni), or any alloy thereof.

In step (a4), the protective gas can, beneficially, be made up of at least one of nitrogen (N₂), ammonia (NH₃), and a noble gas. In step (a5), the carbon source gas can be a hydrocarbon gas, such as ethylene (C₂H₄), methane (CH₄), acetylene (C₂H₂), ethane (C₂H₆), or any combination thereof.

The super-aligned array of carbon nanotubes can, opportunely, have a height of about 200 microns to about 400 microns and include a plurality of carbon nanotubes substantially parallel to each other and approximately perpendicular to the substrate.

In step (b), the drawn carbon nanotube film can be formed by the sub-steps of: (b1) selecting one or more carbon nanotubes having a predetermined width from the array of carbon nanotubes; and (b2) pulling the carbon nanotubes to form nanotube segments at an even/uniform speed to achieve a uniform drawn carbon nanotube film.

In step (b1), the carbon nanotube segment includes a plurality of carbon nanotubes substantially parallel to each other. The carbon nanotube segments can be selected using an adhesive tape as the tool to contact the super-aligned array of carbon nanotubes. In step (b2), the pulling direction is substantially perpendicular to the growing direction of the super-aligned array of carbon nanotubes.

During the pulling process, as the initial carbon nanotube segments are drawn out, other carbon nanotube segments are also drawn out end to end due to van der Waals attractive force between the ends of adjacent carbon nanotube segments. The drawing process ensures a substantially continuous and uniform drawn carbon nanotube film can be formed. The drawn carbon nanotube film formed by the pulling/drawing method has superior uniformity of thickness and conductivity over a disordered carbon nanotube film. Furthermore, the pulling/drawing method is simple, fast, and suitable for industrial applications.

The electrodes 28a, 28b, 28c, 28d are located separately at the corners of a surface of the transparent conductive layer 24. A material of the electrodes 28a, 28b, 28c, 28d can be metal. In one embodiment, the material of the electrodes 8a, 28b, 28c, 28d is silver. The electrodes 28a, 28b, 28c, 28d can be formed at the corners of the transparent conductive layer 24 by methods such as sputtering, electro-plating, or chemical plating. Alternatively, a conductive adhesive, such as silver glue, can be used to adhere the electrodes 28a, 28b, 28c, 28d to the transparent conductive layer 24. The electrodes 28a, 28b, 28c, 28d can be electrically connected to the transparent conductive layer 24.

The chromaticity improving layer 10 can be located on the surface of the transparent conductive layer 24. A material of the chromaticity improving layer 10 can be TiO₂, ZrO₂, Nb₂O₅, Ta₂O₅, Al₂O₃, SiO₂, CeO₂, HfO₂, ZnS, MgF₂ or other dielectric material. The chromaticity improving layer 10 can be formed on the surface of the transparent conductive layer 10 by means such as vacuum evaporating, sputtering, slot coating, spin-coating, or dipping. The chromaticity improving layer 10 can be used to improve the chromaticity of the touch panel 20. In one embodiment, the chromaticity improving layer 26 is a two-layer SiO₂ formed by a dipping method.

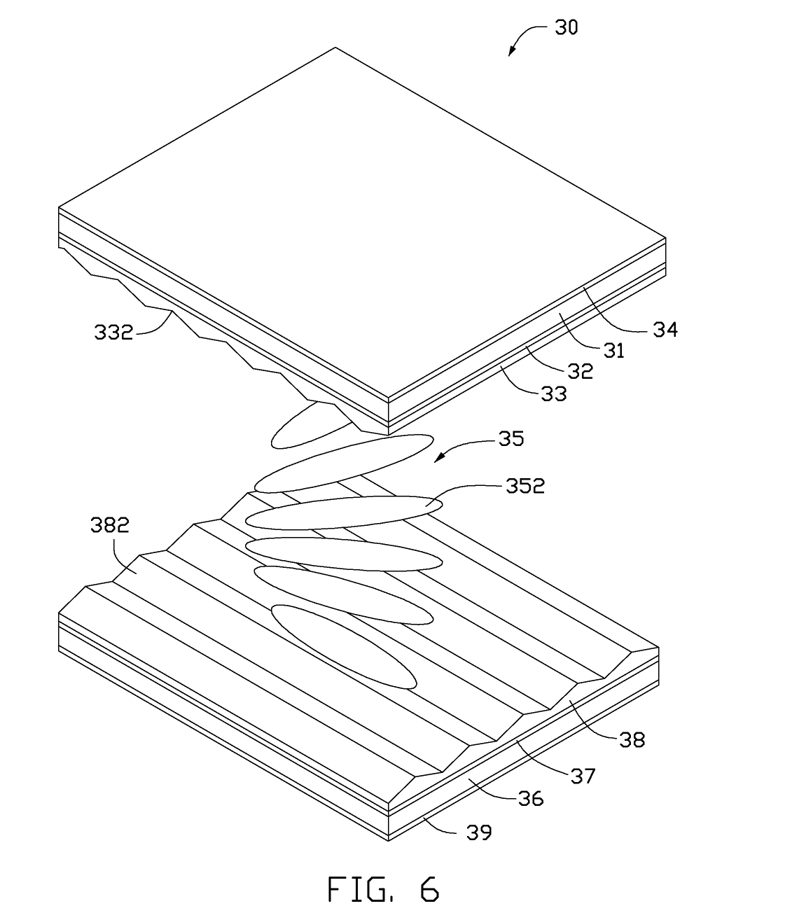

Referring to FIG. 6, the display screen 30 is a liquid crystal display. The display screen 30 includes a first substrate plate 31, a first transparent electrode layer 32, a first alignment layer 33, a first polarizer 34, a liquid crystal layer 35, a second substrate plate 36, a second transparent electrode layer 37, a second alignment layer 38, and a second polarizer 39.

The first substrate plate 31 faces the second substrate plate 36. The liquid crystal layer 35 including a plurality of liquid crystal molecules 352 is sandwiched between the first substrate 31 and the second substrate 36. The first transparent electrode layer 32 is located on a surface of the first substrate plate 31 adjacent to the liquid crystal layer 35. The first alignment layer 33 is located on a surface of the first transparent electrode layer 32 adjacent to the liquid crystal layer 35. The first transparent electrode layer 32 is located between first substrate plate 31 and first alignment layer 33. The first polarizer 34 is located on a surface of the first substrate plate 31 away from the liquid crystal layer 35. The second transparent electrode layer 37 is located on a surface of the second substrate plate 36 adjacent to the liquid crystal layer 35. The second alignment layer 38 is located on a surface of the second transparent electrode layer 37 adjacent to the liquid crystal layer 35. The second transparent electrode layer 37 is located between the second substrate plate 36 and the second alignment layer 38. The second polarizer 39 is located on a surface of the second substrate plate 36 away from the liquid crystal layer 35.

A plurality of substantially parallel first grooves 332 is defined in a surface of the first alignment layer 33 facing the liquid crystal layer 35. A plurality of substantially parallel second grooves 382 is defined in a surface of the second alignment layer 38 facing the liquid crystal layer 35. An alignment direction of the first grooves 332 is substantially perpendicular to an alignment direction of the second grooves 382.

The first substrate plate 31 and second substrate plate 36 are transparent and insulative. A material of the first substrate plate 31 and second substrate plate 36 can be glass, quartz, diamond, or plastic. In one embodiment, both the first substrate plate 31 and second substrate plate 36 are cellulose triacetate (CTA). The first transparent electrode layer 32 and second transparent electrode layer 37 can be conductive polymer layers, ITO layers, or transparent carbon nanotube layers. In one embodiment, the first transparent electrode layer 32 and second transparent electrode layer 37 are ITO layers. The first alignment layer 33 and the second alignment layer 38 can be polymer layers or transparent carbon nanotube layers. In one embodiment, the first alignment layer 33 and the second alignment layer 38 are polyimide layers. The first polarizer 34 and second polarizer 39 can be polymer layers or transparent carbon nanotube layers. In one embodiment, the first polarizer 34 and second polarizer 39 are polymer layers.

If both the touch panel 20 and the display screen 30 include at least one transparent carbon nanotube layer, only one chromaticity improving layer is necessary to improve the chromaticity of the display device 100. The location of the chromaticity improving layer in the display device 100 is not limited, as long as the chromaticity improving layer can be located in a light path of the display device 100, and the display device 100 has approximately the same light transmittance to different wavelengths of visible light. Here, the item ‘light path’ is defined as a path which a light passed through in the display device 100.

Because a light transmittance of the transparent carbon nanotube film to short wavelengths of visible light is lower than the light transmittance to long wavelengths of visible light, a chromaticity will exist on the touch panel 20. The wavelengths of the short wavelength visible light is closer to the lower end of the visible spectrum and the wavelengths of the long wavelength visible light is closer to the higher end of the visible spectrum. The chromaticity of a touch panel can be represented by values of the lab color space of the International Commission on Illumination. Here, a*represents a green-red value of the touch panel, and b*represents a blue-yellow value of the touch panel. In the field of the display, the absolute values of a* and b* are expected to less than 2.0. Preferably, the absolute values of a* and b* are expected to be equal to about 0.

Referring to column 1 of Table 1, column 1 shows values of the lab color space of five touch panels 10, No.1 to No.5. From column 1, the absolute values of a*of the No.1 to No.5 touch panel 20 are less than 2.0. Therefore, there is no need to improve the a*of the No.1 to No.5 touch panel 20. However, the absolute values of b* of the No.1 to No.5 touch panel 20 are greater than 2.0. Thus, the b* of the No.1 to No.5 touch panel 20 need to be improved. The b* of the No.1 to No.5 touch panel 20 can be improved by the chromaticity improving layer 10. The b* of the No.1 to No.5 touch panel 20 is related to the thickness A₁ of the transparent conductive layer 24.

The chromaticity improving layer 10 can cause the touch panel 20 to have approximately the same light transmittance to different wavelengths of visible light. This is because a light transmittance of the chromaticity improving layer 10 to short wavelength visible light can be higher than a light transmittance to long wavelengths visible light. In other words, the chromaticity improving layer 10 can have certain chromaticity itself.

The chromaticity of the chromaticity improving layer 10 can also be represented by the values of the lab color space of the International Commission on Illumination. In one embodiment, the b*of the chromaticity improving layer 10 is in a range from about −16.7×A₁ to about −1.67×A₁. In another embodiment, the b* of the chromaticity improving layer 10 is in a range from about −10.0×A₁ to about −1.67×A₁. In another embodiment, the thickness A₁ of the transparent conductive layer 10 is about 0.3 micrometers, and the b*of the chromaticity improving layer 10 is about −4.0×A₁. Thus, the b*of the chromaticity improving layer 10 is about −1.2.

TABLE 1

| | | |
|---|---|---|
| Column 1 | Column 2 | Column 3 |

| No. | a* | b* | a* | b* | Δa* | Δb* |
|---|---|---|---|---|---|---|
| 1 | 0.18 | 2.27 | −0.22 | 0.92 | −0.40 | −1.35 |
| 2 | −0.12 | 2.21 | −0.33 | 1.01 | −0.21 | −1.20 |
| 3 | −0.09 | 2.58 | −0.46 | 1.20 | −0.37 | −1.38 |
| 4 | 0.23 | 2.83 | −0.23 | 0.92 | −0.46 | −1.91 |
| 5 | 0.16 | 2.33 | −0.26 | 1.03 | −0.42 | −1.30 |
| Average | 0.07 | 2.44 | −0.30 | 1.01 | −0.37 | −1.43 |

Referring to Table 1, column 2 shows values of the lab color space of the No.1 to No.5 touch panel 20 with the chromaticity improving layer 10, and column 3 shows the variation of the lab color space between column 1 and column 2. From the column 2 and column 3, the absolute values of a* of the No.1 to No.5 touch panel 20 with the chromaticity improving layer 10 are less than 2.0. An average variation of a* between the No.1 to No.5 touch panel 20 with the chromaticity improving layer 10 and the No.1 to No.5 touch panel 20 is about −0.37. In other words, the a * of the No.1 to No.5 touch panel 20 remains fundamentally unchanged. The absolute values of b* of the No.1 to No.5 touch panel 20 with the chromaticity improving layer 10 are less than 2.0. An average variation of b*between the No.1 to No.5 touch panel 20 with the chromaticity improving layer 10 and the No.1 to No.5 touch panel 20 is about −1.43. In other words, the b* of the No.1 to No.5 touch panel 20 are significantly changed by the chromaticity improving layer 10. Therefore, the chromaticity of the No.1 to No.5 touch panel 20 is decreased by the chromaticity improving layer 10.

A location of the chromaticity improving layer 10 is not limited, as long as the chromaticity improving layer 10 can be located on the light path of the display device 100. Therefore, the display device 100 can have approximately the same light transmittance to different wavelengths of visible light.

The touch panel 20 can further include a shielding layer 25 located on the second surface 222 of the substrate 22. The shielding layer 25 is connected to the ground and plays a role of shielding electromagnetic interference, and thus enables the touch panel 20 to operate without interference. The shielding layer 25 can be a conductive polymer layer, an ITO layer, or a transparent carbon nanotube layer. In one embodiment, the shielding layer 25 is a transparent carbon nanotube layer. More specifically, the shielding layer 25 is the drawn carbon nanotube film. The thickness of the shielding layer 25 can be defined as A₂ micrometers.

If the touch panel 20 further includes a transparent carbon nanotube layer as a shielding layer 25, the b* of the chromaticity improving layer 10 is related to the thickness A₁ of the transparent carbon nanotube layer and the thickness A₂ of the shielding layer 25. In one embodiment, the b*of the chromaticity improving layer 10 is in a range from about −16.7×(A₁+A₂) to about −1.67×(A₁+A₂). In another embodiment, the b* of the chromaticity improving layer 10 is in a range from about −10.0×(A₁+A₂) to about −1.67×(A₁+A₂).

In operation, when light emitting from the display screen 30 passes through the transparent carbon nanotube layers of transparent conductive layer 24 and shielding layer 25, a chromaticity and a color distortion will exist. However, when the light further passes through the chromaticity improving layer 10, the chromaticity and the color distortion can be improved by the chromaticity improving layer 10, thereby improving the visual effect of the display device 100.

In use of the display device 100, a voltage is applied to the transparent conductive layer 24 via electrodes 28a, 28b, 28c, 28d to form an equipotential surface. When a user operates the display device 100 by contacting the transparent conductive layer 24 of the touch panel 20 with a touching object, such as a finger, a pen, or a stylus, a coupling capacitance is formed between the touching object and the transparent conductive layer 24. Currents then flow from the electrodes 28a, 28b, 28c, 28d to the touching point. The position of the touching point is confirmed by calculating the ratio and the intensity of the current through the electrodes 28a, 28b, 28c, 28d. The first controller 12 then transforms the changes in currents into coordinates of the pressing point, and sends the coordinates of the pressing point to the CPU 13. The CPU 13 then sends out commands according to the coordinates of the pressing point and further controls a display of the display screen 14.

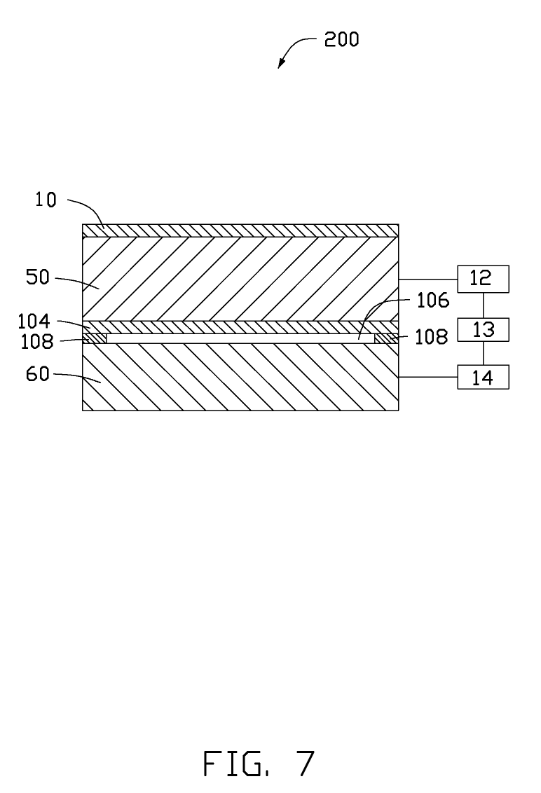

Referring to FIG. 7, a display device 200 of another embodiment is provided. The display device 200 includes a chromaticity improving layer 10, a touch panel 50, a display screen 60, a first controller 12, a central processing unit (CPU) 13, and a second controller 14.

The touch panel 50 is basically the same as the touch panel 20 of display screen 100. The difference is that a transparent conductive layer of the touch panel 50 is an ITO layer. In other words, the touch panel 50 does not include a transparent carbon nanotube layer. Therefore, a chromaticity will not exist on the touch panel 50.

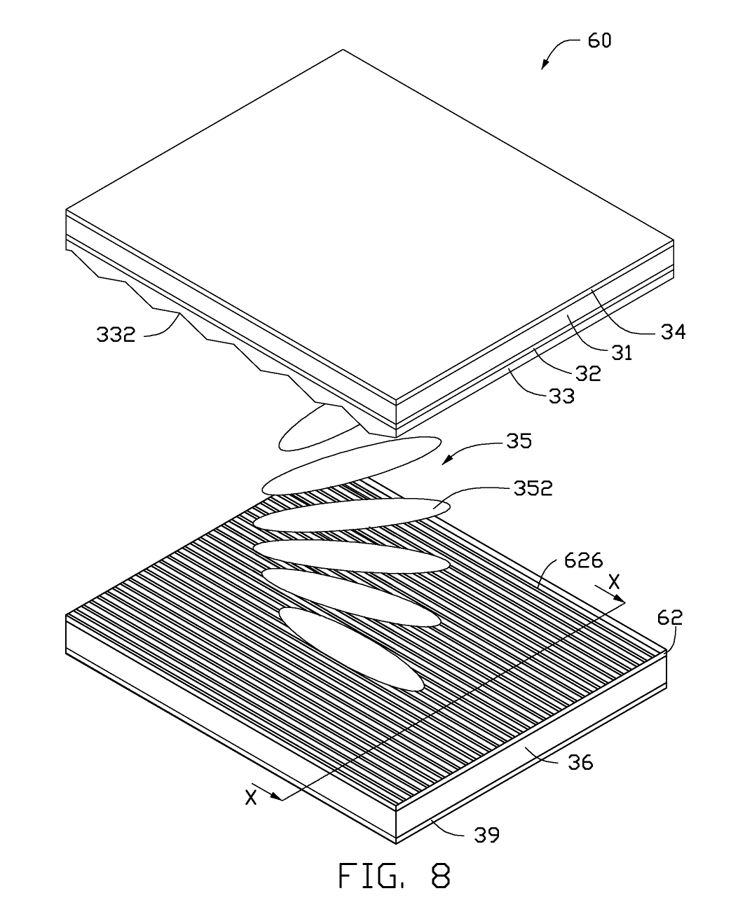

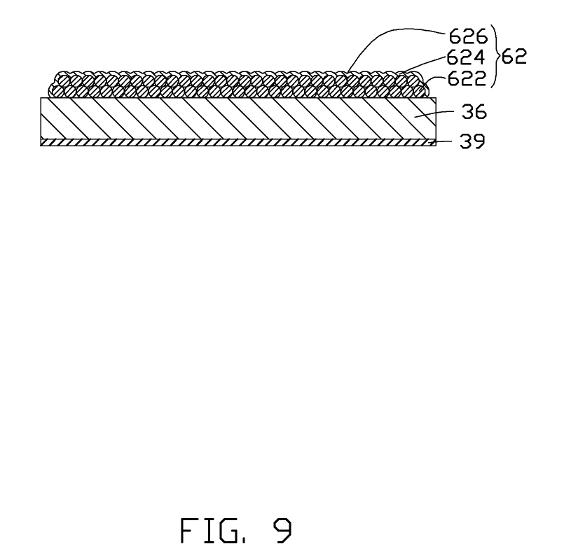

The display screen 60 can be, for example, a liquid crystal display, a field emission display, a plasma display, an electroluminescent display, a vacuum fluorescent display, a cathode ray tube, or another display device. Referring to FIGS. 8 and 9, according to one embodiment, the display screen 60 is a liquid crystal display. The display screen 60 includes a first substrate plate 31, a first transparent electrode layer 32, a first alignment layer 33, a first polarizer 34, a liquid crystal layer 35, a second substrate plate 36, a second alignment layer 62, and a second polarizer 39.

The second alignment layer 62 is located on a surface of the second substrate plate 36 adjacent to the liquid crystal layer 35. The second alignment layer 62 includes a first transparent carbon nanotube layer 622, a fixing layer 624, and a plurality of second grooves 626. The first transparent carbon nanotube layer 622 is located on the surface of the second substrate plate 36 adjacent to the liquid crystal layer 35. The fixing layer 624 is located on a surface of the first transparent carbon nanotube layer 622 adjacent to the liquid crystal layer 35. The plurality of second grooves 626 is located on a surface of the fixing layer 624 adjacent to the liquid crystal layer 35. An alignment direction of the second grooves 626 is substantially perpendicular to the alignment direction of the first grooves 332. The thickness of the first transparent carbon nanotube layer 622 can be defined as A₃ micrometers.

Because the second alignment layer 62 includes the first transparent carbon nanotube layer 622, when a light passes through the first transparent carbon nanotube layer 622, a chromaticity will exist on the display device 200. Therefore, the chromaticity improving layer 10 can be used to make sure that the display screen 60 can have approximately the same light transmittance to different wavelengths of visible light. The b* of the chromaticity improving layer 10 can be related to the thickness A₃ of the first transparent carbon nanotube layer 622. In one embodiment, the b* of the chromaticity improving layer 10 is in a range from about −16.7×A₃ to about −1.67×A₃. In other embodiment, the b*of the chromaticity improving layer 10 is in a range from about −10.0×A₃ to about −1.67×A₃.

The display screen 60 can include a second transparent carbon nanotube layer. The second transparent carbon nanotube layer can be used as the first transparent electrode layer 32, the first alignment layer 33, the first polarizer 34, and the second polarizer 39. The thickness of the second transparent carbon nanotube layer can be defined as A₄ micrometers. If the display screen 60 further includes a second transparent carbon nanotube layer, the b* of the chromaticity improving layer 10 can be in a range from about −16.7×(A₃+A₄) to about −1.67×(A₃+A₄). More preferred, the b* of the chromaticity improving layer 10 can be in a range from about −10.0×(A₃+A₄) to about −1.67×(A₃+A₄).

In another embodiment, the display device 200 includes a chromaticity improving layer 10, a display screen 60, a central processing unit (CPU) 13, and a second controller 14. The chromaticity improving layer 10 is located in the display screen 60. The display screen 60, the second controller 14, and the CUP 13 electrically connected with each other. Because the display screen 60 includes at least one transparent carbon nanotube layer, when light passes through the display screen 60, a chromaticity will exist on the display device 200. Therefore, the chromaticity improving layer 10 can be used to improve the chromaticity of display device 200. A location of the chromaticity improving layer 10 is not limited, as long as the chromaticity improving layer 10 is located in a light path of the display screen 60 so that the display screen 60 has approximately the same light transmittance to different wavelengths of visible light. The chromaticity improving layer 10 can be also used to improve the chromaticity caused by other optical elements, such as a transparent electrode layer, an alignment layer, or a polarizer in the display screen 60.

Furthermore, because the light transmittance of the transparent carbon nanotube layer to short wavelengths of visible light is lower than the light transmittance to long wavelengths of visible light, the transparent carbon nanotube layer itself can be used as a chromaticity improving layer. For example, if one of the optical elements in the touch panel or display screen has a higher light transmittance to short wavelengths of visible light than to long wavelengths of visible light, a transparent carbon nanotube layer can be used so that the touch panel or display screen can have approximately the same light transmittance to different wavelengths of visible light. Thus, the visual effect of the touch panel or display screen can be improved.

It is to be understood the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

What is claimed is:

1. A display screen comprising:
an optical element having a lower light transmittance to short wavelength visible light than to long wavelength visible light; and
a chromaticity improving layer having a higher light transmittance to short wavelength visible light than to long wavelength visible light, wherein wavelengths of the short wavelength visible light is closer to the lower end of the visible spectrum and wavelengths of the long wavelength visible light is closer to the higher end of the visible spectrum.

2. The display screen as claimed in claim 1, wherein a material of the chromaticity improving layer is selected from the group consisting of TiO₂, ZrO₂, Nb₂O₅, Ta₂O₅, Al₂O₃, SiO₂, CeO₂, HfO₂, ZnS, and MgF₂.

3. The display screen as claimed in claim 1, wherein the chromaticity improving layer is formed by means of vacuum evaporating, sputtering, slot coating, spin-coating, or dipping.

4. The display screen as claimed in claim 1, wherein the optical element comprises a first transparent carbon nanotube layer.

5. The display screen as claimed in claim 4, wherein a thickness of the first transparent carbon nanotube layer is defined as A in micrometers, and a blue-yellow value of the chromaticity improving layer is in a range from about −16.7×A to about −1.67×A.

6. The display screen as claimed in claim 5, wherein the blue-yellow value of the chromaticity improving layer is in a range from about −10.0×A to about −1.67×A.

7. The display screen as claimed in claim 4, wherein a thickness of the first transparent carbon nanotube layer is about 0.3 micrometers, and a blue-yellow value of the chromaticity improving layer is about −1.2.

8. The display screen as claimed in claim 5, further comprising a second optical element, the second optical element comprising a second transparent carbon nanotube layer.

9. The display screen as claimed in claim 8, wherein a thickness of the second transparent carbon nanotube layer is defined as B in micrometers, and the blue-yellow value of the chromaticity improving layer is in a range from about −16.7×(A+B) to about −1.67×(A+B).

10. The display screen as claimed in claim 8, wherein the first transparent carbon nanotube layer and the second transparent carbon nanotube layer comprise a plurality of carbon nanotubes combined end to end by van der Waals attractive force and arranged approximately along a same direction.

11. A display device comprising:
a display screen and a touch panel opposite and adjacent to the display screen;
the display screen comprising:
at least one optical element having a lower light transmittance to short wavelength visible light than to long wavelength visible light; and
a chromaticity improving layer having a higher light transmittance to short wavelength visible light than to long wavelength visible light, wherein wavelengths of the short wavelength visible light is closer to the lower end of the visible spectrum and wavelengths of the long wavelength visible light is closer to the higher end of the visible spectrum.

12. The display device as claimed in claim 11, wherein a thickness of the at least one optical element is defined as A in micrometers, and a blue-yellow value of the chromaticity improving layer is in a range from about −16.7×A to about −1.67×A.

13. The display device as claimed in claim 11, wherein the chromaticity improving layer is located in the display screen or the touch panel.

14. The display device as claimed in claim 12, further comprising a second optical element having a lower light transmittance to short wavelength visible light than to long wavelength visible light.

15. The display device as claimed in claim 14, wherein the second optical element comprises a second transparent carbon nanotube layer.

16. The display device as claimed in claim 14, wherein a thickness of the second optical element is defined as B in micrometers, and a blue-yellow value of the chromaticity improving layer is in a range from about −16.7×(A+B) to about −1.67×(A+B).

17. A display screen comprising:
at least one optical element having a higher light transmittance to short wavelength visible light than to long wavelength visible light; and
a chromaticity improving layer having a lower light transmittance to short wavelength visible light than to long wavelength visible light, wherein wavelengths of the short wavelength visible light is closer to the lower end of the visible spectrum and wavelengths of the long wavelength visible light is closer to the higher end of the visible spectrum.

18. The display screen as claimed in claim 17, wherein the chromaticity improving layer comprises a first transparent carbon nanotube layer.

19. The display screen as claimed in claim 18, wherein the first transparent carbon nanotube layer comprises a plurality of carbon nanotubes combined end to end by van der Waals attractive force and arranged approximately along a same direction.
